(19) United States
(12) Patent Application Publication
(10) Pub. No.: US 2012/0272314 A1
(43) Pub. Date: Oct. 25, 2012

(54) DATA COLLECTION SYSTEM

(75) Inventor: Barrett Gibson Lyon, Pacifica, CA (US)

(73) Assignee: CYBYL TECHNOLOGIES, INC., San Mateo, CA (US)

(21) Appl. No.: 13/092,056

(22) Filed: Apr. 21, 2011

(51) Int. Cl. G06F 21/00

(52) U.S. Cl. 726/22

(57) ABSTRACT

A data collection system for generating alerts is disclosed. In some embodiments, information is gathered from a plurality of internet facilities that are used for malicious purposes. In response to detecting in the gathered information data that satisfies an alert condition associated with malicious activity, an alert to warn a potential target of the malicious activity is generated.

### BACKGROUND OF THE INVENTION

Typical web search engines are unable to crawl networks on the Internet that have limited or restricted access. Thus, the corpus of content discoverable by web search engines is limited, and certain types of content may not be amenable to discovery by typical web search engines.

### BRIEF DESCRIPTION OF THE DRAWINGS

Various embodiments of the invention are disclosed in the following detailed description and the accompanying drawings.

FIG. 1A is a high level block diagram illustrating an embodiment of a data collection system.

FIG. 1B is a high level block diagram illustrating various types of internet facilities from which data may be input into an embodiment of a data collection system.

FIG. 2 illustrates an embodiment of a process for storing data collected by a data collection system.

FIG. 3 illustrates an embodiment of a process for generating alerts.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims, and the invention encompasses numerous alternatives, modifications, and equivalents. Numerous specific details are set forth in the following description in order to provide a thorough understanding of the invention. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

Cyber criminals rely on remaining anonymous over networks such as the Internet when engaging in various malicious activities. Despite attempts to maintain anonymity, malicious entities often nevertheless inadvertently expose sensitive and potentially identifying information during benign use of various internet facilities. Various techniques for monitoring cyber activity across one or more internet portals and collecting and analyzing information as well as employing such information to profile malicious or suspect entities and activities and to alert potential targets are disclosed herein.

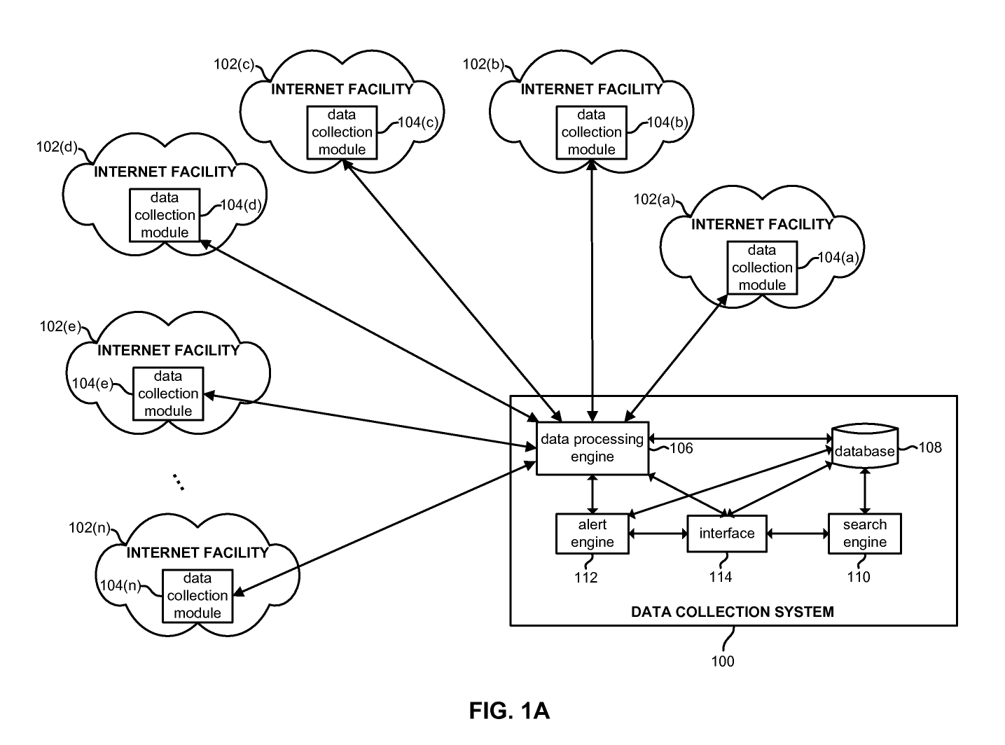

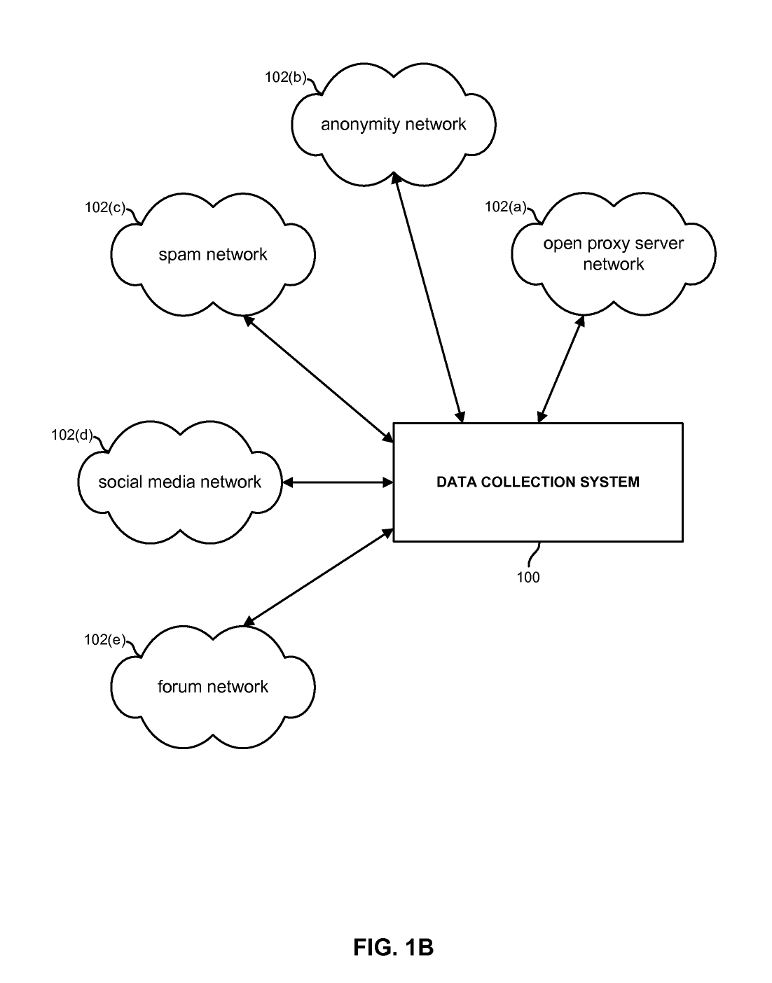

FIG. 1A is a high level block diagram illustrating an embodiment of a data collection system. As depicted in the given example, data is input into data collection system 100 from one or more internet facilities 102. Examples of internet facilities that may be employed with respect to data collection system 100 are further described below with respect to FIG. 1B. One or more of internet facilities 102 may have restricted and/or vetted access. As a result, information associated with such an internet facility may not be discoverable by search engine crawlers. Registered user accounts, special client-side applications, and/or particular host configurations may be required to access an internet facility and/or gain entry into an associated network. In some embodiments, one or more data collection modules 104 are deliberately configured and/or deployed to monitor traffic and collect data associated with an internet facility 102. In some such cases, a crawler may be employed by a data collection module to crawl a network of the associated internet facility and gather data. Various filters may be employed with respect to data collection modules 104 to gather more relevant data. For instance, a data collection module may be configured to detect and collect any data associated with malicious or suspect users and/or activity as well as any data associated with potential targets of malicious activity but may be configured to filter out data associated with solely benign users and/or activity.

Data collection modules 104 may comprise any appropriate hardware and/or software components, such as user accounts and/or host devices, configured to monitor activity with respect to associated internet facilities 102 and gather relevant information. Although depicted as a single block in FIG. 1A, each data collection module 104 may in various embodiments comprise a plurality of units, for example, deployed across an associated internet facility network. Data collected by data collection modules 104 is input into data collection system 100. In the given example, data collection system 100 includes data processing engine 106, database 108, search engine 110, alert engine 112, and interface 114. In other embodiments, data collection system 100 may comprise any other appropriate hardware and/or software components and/or configuration and in some embodiments may comprise a plurality of units, for example, networked around the world.

Data input into data collection system 100 is processed by data processing engine 106. Data processing may comprise normalizing data, analyzing data, data mining, identifying relevant data, computing statistics, categorizing data, correlating data, aggregating related data, indexing data for searches, etc. Related sets of data, such as data associated with a particular entity or keyword, are stored in database 108. In some embodiments, database 108 comprises a searchable database from which data of interest may be retrieved using search engine 110. Data from data processing engine 106 and/or database 108 may in some embodiments be employed by alert engine 112 to generate alerts when certain data, such as data associated with malicious activity, is detected. Data collection system 100 further comprises an interface 114. In some embodiments, interface 114 comprises a dashboard. In some embodiments, interface 114 comprises an API (Application Programming Interface). In some embodiments, interface 114 may be employed to at least in part configure and/or tune data collection system 100. For example, the types of data to monitor and collect and/or actions to take if particular types of data are found may in some embodiments be configurable via interface 114. Moreover, interface 114 may comprise an interface for searching database 108 via search engine 110 and presenting search results. Furthermore, interface 114 may present other data that may be of interest, such as real time data collection, traffic analysis, and/or processing results, which may be presented in some embodiments via one or more gauges or other appropriate user interface widgets.

FIG. 1B is a high level block diagram illustrating various types of internet facilities from which data may be input into an embodiment of a data collection system. Although some examples of internet facilities 102 are provided in FIG. 1B, in various embodiments, data may be input into data collection system 100 from any one or more appropriate data sources. Data collection system 100 may effectively be employed to tap the virtual networks of various internet facilities 102 that users may not expect to be surveilled and to gather data on unsuspecting entities that may employ the facilities to conduct malicious activity. In some embodiments, both malicious and benign use by an entity of an internet facility is tracked, so that, for example, the entity can be profiled. For example, an entity's browsing and other usage patterns may be tracked. Entities using an internet facility for purportedly anonymous activities often continue to use the internet facility for personal use and transactions, such as accessing personal information and accounts that could compromise their identities such as accounts associated with various sites or portals, email accounts, social media accounts, e-commerce accounts, etc. In such cases, sensitive information associated with an entity such as log-in information and/or session identifiers may be collected. Such information may be employed by the data collection system to access and data mine personal accounts for information associated with an entity, which is correlated and stored with other data profiling the entity. In addition to monitoring and profiling malicious and/or suspect entities and activities, other information may be gathered using one or more internet facilities 102 such as information pertaining to particular topics or keywords, identified threats or impending attacks, potential targets of malicious activity, etc. Such information may be aggregated and stored by data collection system 100 and may be used to thwart malicious activity or generate alerts in advance. Furthermore, one or more of internet facilities 102 may be employed to gather general internet usage data and statistics as well as performance metrics. In the example of FIG. 1B, data is input into data collection system 100 from open proxy server network 102(a), anonymity network 102(b), spam network 102(c), social media network 102(d), and forum network 102(e). Each of these internet facilities is further described below.

In some embodiments, data is input into data collection system 100 from a network of one or more open proxy servers 102(a) that have been configured to monitor traffic and collect data. The IP (Internet Protocol) address of a proxy server serves as the source address for activity conducted using the proxy server, thereby concealing the actual source of the activity and preserving anonymity. Although open proxy servers may be employed for benign activity such as circumventing internet censorship, they are often employed by entities who desire to remain anonymous when conducting malicious activity. A highly monitored stealth network of open proxy servers 102(a) is in some embodiments employed to lure malicious entities desiring to mask their identities. The existence of such open proxy servers may be publicized by manually adding them to lists of open proxy servers available on the Internet and/or may be discovered by entities actively scanning for open proxy servers. Due to their public nature, open proxy servers typically experience an enormous amount of traffic, and such traffic can be monitored, analyzed, and/or cataloged as desired. Open proxy servers may be advantageously employed to not only detect malicious or suspect activity by entities but also to learn sensitive information about such entities if they continue to the use the proxy servers for benign purposes that may reveal or aid in revealing their actual identities such as logging into and/or establishing sessions with respect to personal accounts.

In some embodiments, data is input into data collection system 100 from host devices configured to operate as nodes of an anonymity network 102(b) such as Tor. Anonymous communications over such a network may be facilitated, for example, using onion routing. Each node of an anonymity network may operate as an entrance node, a transit node, and/or an exit node of the network. In some embodiments, a sufficiently large number of devices may be deliberately configured to operate as nodes of anonymity network 102(b) so that a substantial portion of traffic associated with network 102(b) traverses the devices. Such traffic may be analyzed, and traffic seen by different devices may be correlated, possibly at least partially compromising the obfuscation of such communications. Moreover, any collected data may be further correlated with other data collected by data collection system 100.

In some embodiments, spam 102(c) is collected from various sources and input into data collection system 100. Spam may be collected, for instance, using a dedicated set of email accounts deliberately set up to elicit spam. In such cases, the associated email addresses may be employed to sign up for or create accounts on various sites expected to make the email addresses available to spammers. Spam harvested from these email accounts is analyzed by data collection system 100, for example, to identify threats such as phishing and spoofing attacks and to provide early notifications or alerts to potential targets. The analysis may include searching for keyword matches as well as correlating data from spam with other data collected by data collection system 100 via other internet facilities, for instance, to aid in identifying the origin or source of the spam. For example, if substantial references to a prominent financial institution are found to occur or occur frequently in spam messages, the financial institution may be alerted, and the origin or source of a potential attack may be identified by recognizing relationships that may exist between data harvested from spam and other information processed by data collection system 100.

In some embodiments, data is input into data collection system 100 from one or more social media networks 102(d). Many social media networks are at least not fully accessible without a registered user account. Moreover, an account holder may have limited access to only certain portions of the network. Thus, much of the data on such networks cannot be discovered or surfaced by search engine crawlers. However, a set of dedicated accounts may be deliberately set up or created to collect information from such networks. Crawlers may be employed with respect to such accounts to facilitate gathering of data. Any data gathered from a social media network may be mined and correlated with other data processed by data collection system 100.

In some embodiments, data is input into data collection system 100 from one or more forums 102(e). Content on many forums is accessible only to registered and/or vetted users and, thus, not discoverable by search engine crawlers. However, forums such as those associated with the hacker community are typically rife with intelligence on existing security breaches, security vulnerabilities, targets or potential targets, and other malicious activity. In some embodiments, a set of user accounts are deliberately created to gain access or entry into such forums. Crawlers may be employed with respect to such accounts to facilitate gathering of data. Furthermore, one or more dedicated forums may deliberately be deployed to attract various types of malicious entities. Such forums and/or forum accounts may be employed to seed posts related to particular topics and to entice other forum members to post information related to the topics. Any data gathered from a forum may be mined and correlated with other data processed by data collection system 100.

Although some examples of internet facilities that may be employed to feed data into data collection system 100 have been described, data may be input into data collection system 100 in various embodiments from any other appropriate data sources. Similar to the manner described for open proxy servers, data may be mined from any internet access point or resource that is left or configured open such as an open VPN (Virtual Private Network) server. Moreover, data may be mined from web sites, chat rooms, messaging services, IRC (Internet Relay Chat) networks, P2P (peer-to-peer) networks, etc. Malicious activity or intent may be detected by specifically surveilling internet facilities that are often or may be used for nefarious purposes. Data received by data collection system 100 from various sources is analyzed and correlated so that data associated with particular entities, activities, keywords, etc., may be aggregated and stored in database 108 as well as used by alert engine 112 to generate appropriate alerts for targets or potential targets of malicious activity. In some embodiments, data associated with both benign and malicious use is aggregated. Some of the data associated with an entity that is harvested from benign use by the entity, for example, may be employed to at least in part unmask the identity of the entity, for example, if the entity is found to be associated with malicious activity.

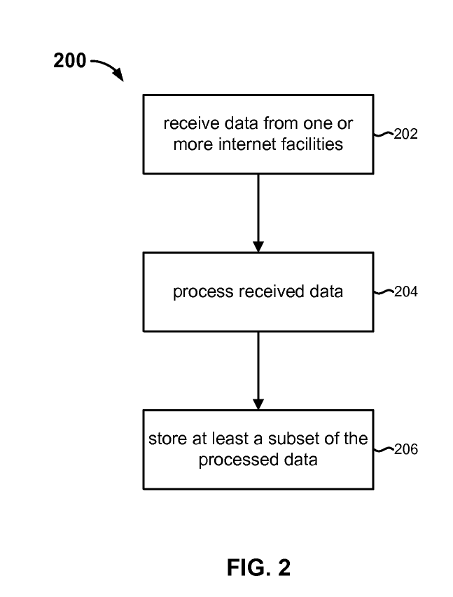

FIG. 2 illustrates an embodiment of a process for storing data collected by a data collection system. In some embodiments, process 200 is employed by data collection system 100 of FIGS. 1A-1B. Process 200 starts at 202 at which data is received from one or more internet facilities. As described, data may be received from internet facilities such as an open proxy server network or other open internet access resource, an anonymity network, a spam network, a social media network, an IRC network, a P2P network, a messaging network, a forum, a chat room, a web site, or any other appropriate data source. At 204, the received data is processed. Data processing may comprise normalizing data, analyzing data, data mining, identifying relevant data, computing statistics, categorizing data, correlating data, aggregating related data, indexing data for searches, etc. At 206, at least a subset of the processed data is stored. In some embodiments, correlated data is aggregated and stored in a database, such as database 108, in a manner such that the data can be collectively retrieved. In some cases, step 206 includes storing and/or linking at least some of the processed data with one or more existing records of a database, for example, if the data has been correlated to existing data already stored in the database. In some cases, step 206 includes storing at least some of the processed data in one or more new records, for example, if no relationships are found to exist between the data and other data already processed and/or stored by the system. The database may be indexed and searched using any appropriate identification parameters. For example, a database comprising profiles of entities may be indexed and searched by parameters such as IP addresses, host names, domain names, cookies (e.g., if cookies are set and tracked with respect to one or more internet facilities), email or other user accounts, keywords, etc. In various embodiments, data of interest may be retrieved from the database using any appropriate search techniques such as manual or human searches, software or algorithm-based searches, searches based on pre-defined search patterns, etc. In some embodiments, an API is provided that may be employed to interface with the data collection system and search and retrieve data.

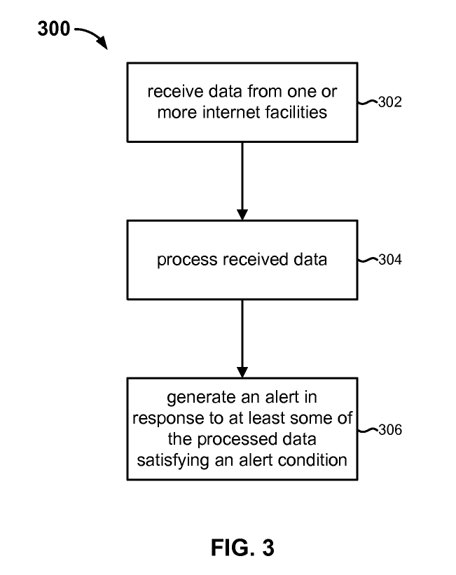

FIG. 3 illustrates an embodiment of a process for generating alerts. In some embodiments, process 300 is employed by data collection system 100 of FIGS. 1A-1B. Process 300 starts at 302 at which data is received from one or more internet facilities. As described, data may be received from internet facilities such as an open proxy server network or other open internet access resource, an anonymity network, a spam network, a social media network, an IRC network, a P2P network, a messaging network, a forum, a chat room, a web site, or any other appropriate data source. At 304, the received data is processed. Data processing may comprise normalizing data, analyzing data, data mining, identifying relevant data, computing statistics, categorizing data, correlating data, aggregating related data, indexing data for searches, etc. In some embodiments, correlated data is aggregated and stored in a database, such as database 108. At 306, an alert is generated in response to at least some of the processed data satisfying an alert condition. In various embodiments, data that triggers an alert at 306 may comprise newly processed data and/or previously processed and stored data. Any appropriate conditions or criteria may be employed to trigger alarms or alerts. Moreover, different types of alerts may be generated in response to different criteria or conditions being satisfied. For example, the alert may comprise an email or other notification to a target or potential target of an impending attack. The alert generated at 306 may be provided to an entity such as a representative of a target of an attack or a security operations center. Alternatively, the alert generated at 306 may be conveyed via software to another system, e.g., via an associated API. In some such cases, for instance, the alert generated at 306 may comprise a trap, exception, or fault condition. In some embodiments, instead of or in addition to generating an alert, one or more actions may be executed at 306 if processed data is found to satisfy one or more prescribed conditions or criteria.

As described, the data collection system disclosed herein aids in generating awareness of current or real time Internet activity and strives to prevent or at least mitigate attacks or exploits as well as identify perpetrators of such activities. Services available via such a data collection system include, but are not limited to, providing a criminal profile database, providing criminal tracking, providing threshold triggers and alerts (e.g., distributed denial-of-service (DDoS) attacks may be detected based on increased traffic to targets and perpetrating as well as targeted parties may be identified), gathering performance data (e.g., on a network or host on the Internet), identifying Internet usage patterns, etc.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for generating an alert, comprising:
a processor configured to:
process information gathered from a plurality of internet facilities that are used for malicious purposes;
detect in the gathered information data that satisfies an alert condition associated with malicious activity; and
generate an alert to warn a potential target of the malicious activity; and
a memory coupled to the processor and configured to provide the processor with instructions.

2. The system of claim 1, wherein the processor is further configured to determine correlations in the gathered information and aggregate correlated information.

3. The system of claim 2, wherein aggregated correlated information comprises data associated with both benign use and malicious use of one or more of the plurality of internet is facilities.

4. The system of claim 2, wherein aggregated correlated information comprises data at least in part identifying an entity with which the aggregated correlated information is associated.

5. The system of claim 1, wherein the processor is further configured to provide to the potential target other information that has been correlated to the data that triggered the alert.

6. The system of claim 5, wherein other information that has been correlated to the data that triggered the alert comprises data at least in part identifying a perpetrator of the malicious activity.

7. The system of claim 1, wherein the plurality of internet facilities comprises one or more of: an open internet access resource, an open proxy server network, an open virtual private network server, an anonymity network, a spam network, a social media network, an IRC (Internet Relay Chat) network, a P2P (peer-to-peer) network, a messaging network, a forum, a chat room, and a web site.

8. The system of claim 1, wherein each of the plurality of internet facilities is also used for benign purposes.

9. The system of claim 1, wherein at least one of the plurality of internet facilities has restricted access.

10. The system of claim 1, wherein at least one of the plurality of internet facilities at least in part provides user anonymity.

11. The system of claim 1, wherein the alert comprises a trap, exception, or fault condition.

12. The system of claim 1, wherein the processor is further configured to execute an action in response to detecting the data that satisfies the alert condition.

13. A method for generating an alert, comprising:
processing information gathered from a plurality of internet facilities that are used for malicious purposes;
detecting in the gathered information data that satisfies an alert condition associated with malicious activity; and
generating an alert to warn a potential target of the malicious activity.

14. The method of claim 13, further comprising determining correlations in the gathered information and aggregating correlated information.

15. The method of claim 14, wherein aggregated correlated information comprises data at least in part identifying an entity with which the aggregated correlated information is associated.

16. The method of claim 13, further comprising providing to the potential target other information that has been correlated to the data that triggered the alert.

17. The method of claim 13, further comprising executing an action in response to detecting the data that satisfies the alert condition.

18. A computer program product for generating an alert, the computer program product being embodied in a computer readable storage medium and comprising computer instructions for:
processing information gathered from a plurality of internet facilities that are used for malicious purposes;
detecting in the gathered information data that satisfies an alert condition associated with malicious activity; and
generating an alert to warn a potential target of the malicious activity.

19. The computer program product recited in claim 18, further comprising computer instructions for determining correlations in the gathered information and aggregating correlated information.

20. The computer program product recited in claim 18, further comprising computer instructions for providing to the potential target other information that has been correlated to the data that triggered the alert.
